(19) United States
(12) Patent Application Publication
(10) Pub. No.: US 2014/0184541 A1
(43) Pub. Date: Jul. 3, 2014

(54) Processing Apparatus of Optical Touch System and Operating Method Thereof

(71) Applicant: EGALAX_EMPIA TECHNOLOGY INC., Taipei City (TW)

(72) Inventor: SHANG-TAI YEH, TAIPEI CITY (TW)

(73) Assignee: EGALAX_EMPIA TECHNOLOGY INC., TAIPEI CITY (TW)

(21) Appl. No.: 14/140,795

(22) Filed: Dec. 26, 2013

(30) Foreign Application Priority Data
Dec. 28, 2012 (TW) 101150805

(51) Int. Cl. G06F 3/041

(52) U.S. Cl. CPC G06F 3/041
USPC 345/173

(57) ABSTRACT

An operating method of an optical touch system is provided. The method includes the following steps of: performing at least one test sensing step for obtaining a luminance characteristic value until the luminance characteristic value is smaller than a first threshold value, the test sensing period of each test sensing step is shorter than the period of the previous test sensing step; performing at least one subsequent sensing step based on the test sensing period of the last test sensing step for obtaining a subsequent image; calculating a sensing image based on the at least one subsequent image; and performing a position determining step of each object shown on the sensing image.

### BACKGROUND OF THE INVENTION

1. Field of the Invention

The present invention relates to an optical touch system, and more particularly, to an optical touch system that is operable under the interference of light and an operating method thereof.

2. Description of the Prior Art

Among various kinds of human-machine interfaces in current electronic systems, touch control interface is one of the most user-friendly and intuitive type of interfaces. Currently, there are lots of different techniques for achieving touch control. For applications requiring large touch areas, optical touch control may be one of the more economical techniques.

In general, a current optical touch system can be seen in FIG. 1, which is a schematic diagram of an existing optical touch system 100. The optical touch system 100 includes a touch area 110. At least two corners of the touch area 110 are installed with optical assemblies 130a and 130b, respectively. The optical assemblies 130a and 130b may each include a sensor and a light source. The field of view of the sensor and the projection range of the light source may both cover the entire touch area 110.

The touch area 110 may be surrounded by reflective strips or reflective plates 120. When the light of the optical assemblies 130a and 130b strike the touch area 110 and the reflective strips 120, the two optical sensors may sense the light reflected by the reflective strips 120. The optical sensors and the light sources may sense and project light with wavelengths in the ranges invisible to human eyes, such as in the infrared wave band.

Referring to FIG. 2A, a schematic diagram illustrating luminance values detected by the sensor is shown. The horizontal axis of the diagram represents the field of view of the sensor, that is, the touch area 110 visible to the sensor. The vertical axis represents the luminance values detected by the sensor. Since reflective strips 120 are at the edges of the touch area 110, so the luminance values detected by the sensor is fairly uniform. Under normal conditions with no interference, the amount of light reflected by the reflective strips 120 all falls within a saturation value of the sensor in a predetermined sensing period. The amount of light accumulated by the sensor in this predetermined sensing period will not exceed the upper limit of saturation of the sensor.

When an object 140 touches the touch area 110, as the object 140 blocks some of the light projected by the optical assemblies 130a and 130b, there will be two shaded areas 150a and 150b, or called shaded profiles herein) on the reflective strip 120, wherein the shaded area 150a is the result of the object 140 blocking the light from the optical assembly 130a, and the shaded area 150b is the result of the object 140 blocking the light from the optical assembly 130b.

Referring to FIG. 2B, a schematic diagram illustrating the luminance values detected by the sensor is shown. The horizontal and vertical axes are the same as those shown in FIG. 2A. Since two shaded areas 150a and 150b are created due to the object 140, two depressions can be seen in FIG. 2. It can be seen that there are relative large gaps between the bottom values of the depressions and the average luminance value of the reflective strips 120. In other words, the signal-to-noise ratio is good.

Therefore, when an image sensed by the two optical sensors is sent to a processing apparatus, the processing apparatus may perform a position judging step based on the stereovision of the two sensors to determine the position of the object 140 on the touch area 110. One with ordinary skill in the art can appreciate that determining the position of an object through the use of two or more sensors is well known in the art, and is not the emphasis of the present invention. Therefore, it will not be further illustrated herein.

However, the ideal situation shown in FIG. 2B may be violated with the interference of external light. The interference is shown in the figures described as follow. Referring to FIG. 2C, a schematic diagram illustrating luminance values detected by the sensor subjected to a comprehensive interference. Compared to FIG. 2B, since the external light is uniformly projected onto the touch area 110, so a uniform value is added to the luminance measured in FIG. 2B, resulting in a curve that is higher than the saturation value of the sensor in FIG. 2C. However, when the sensor performs sensing in the original predetermined sensing period, the luminance value of the interference light is enough to saturate the sensor, so the value measured by the sensor is equivalent to the saturation value. As such, it is not possible for the processing apparatus to determine the position of the object 140.

Referring to FIG. 2D, a schematic diagram illustrating luminance values detected by the sensor subjected to a comprehensive interference. Similar to FIG. 2C, the external light is uniformly projected onto the touch area 110, so a uniform value is added to the luminance measured in FIG. 2B, resulting in a curve of FIG. 2D where some part of the curve is higher than the saturation value of the sensor in FIG. 2C. However, when the sensor performs sensing in the original predetermined sensing period, the luminance value of the interference light is enough to saturate most of the regions. Although the luminance values of the shaded areas have not reached the saturation value, they may likely be higher than the original average luminance of the reflective strips 120. As such, it is not possible for the processing apparatus to know if there are shaded areas hidden in those regions with saturated luminance value, and the original algorithm cannot be used to detect the position of the object 140.

Referring to FIG. 2E, a schematic diagram illustrating luminance values detected by the sensor subjected to a partial interference. In contrast to FIGS. 2C and 2D, the left half of the field of view of the sensor is interference by light, so most of the luminance values in the left half of the field of view reach saturation except for where the depression of a shaded area is. However, the right half of the field of view remains normal (no interference). As such, it is not possible for the processing apparatus to know if there are shaded areas hidden in those regions with saturated luminance value, and the original algorithm cannot be used to detect the position of the object 140.

In summary, when the sensors perform sensing in a fixed predetermined sensing period and are being interfered comprehensively or partially, the processing apparatus is unable to know if there are shaded areas hidden in those regions with luminance values exceeding or close to the saturated value of the sensors, and therefore unable to detect the position of the object 140. Thus, there is a need for an optical touch system for determining the positions of objects in the touch area under interference and the operating method thereof.

### SUMMARY OF THE INVENTION

In accordance with an embodiment of the present invention, the present invention provides an operating method of an optical touch system. The operating method may include the following steps of: performing at least one test sensing step to obtain a luminance characteristic value until the luminance characteristic value is smaller than a first threshold value, the test sensing period of each test sensing step is shorter than the test sensing period of the previous test sensing step; performing at least one subsequent sensing step to obtain at least one subsequent image based on the test sensing period of the last test sensing step; calculating a sensing image based on the at least one subsequent image; and performing a position determining step to determine the position of each object in the sensing image.

In accordance with another embodiment of the present invention, the present invention provides an operating method of an optical touch system. The operating method may include the following steps of: performing at least one test sensing step to carry out optical sensing in a test sensing period to obtain a first luminance characteristic value and a second luminance characteristic value of a test image, wherein the test sensing period is shorter than a predetermined sensing period; when the first luminance characteristic value and the second luminance characteristic value satisfy a test condition, performing at least one subsequent sensing step to obtain at least one subsequent image; calculating a sensing image based on the subsequent image; and when the sensing image satisfies a sensing condition, performing calculation of optical touch control based on the sensing image.

In accordance with an embodiment of the present invention, the present invention provides a processing apparatus applicable to an optical touch system for processing a plurality of optical sensors of the optical touch system. The processing apparatus may include: an optical sensor interface connected with the plurality of optical sensors; a memory interface connected with a memory; and a calculation module connected with the optical sensor interface and the memory interface for executing an operating method in accordance with instructions stored in the memory. The operating method may include the following steps of: performing at least one test sensing step to obtain a luminance characteristic value until the luminance characteristic value is smaller than a first threshold value, the test sensing period of each test sensing step is shorter than the test sensing period of the previous test sensing step; performing at least one subsequent sensing step to obtain at least one subsequent image based on the test sensing period of the last test sensing step; calculating a sensing image based on the at least one subsequent image; and performing a position determining step to determine the position of each object in the sensing image.

In accordance with another embodiment of the present invention, the present invention provides a processing apparatus applicable to an optical touch system for processing a plurality of optical sensors of the optical touch system. The processing apparatus may include: an optical sensor interface connected with the plurality of optical sensors; a memory interface connected with a memory; and a calculation module connected with the optical sensor interface and the memory interface for executing an operating method in accordance with instructions stored in the memory. The operating method may include the following steps of: performing at least one test sensing step to carry out optical sensing in a test sensing period to obtain a first luminance characteristic value and a second luminance characteristic value of a test image, wherein the test sensing period is shorter than a predetermined sensing period; when the first luminance characteristic value and the second luminance characteristic value satisfy a test condition, performing at least one subsequent sensing step to obtain at least one subsequent image; calculating a sensing image based on the subsequent image; and when the sensing image satisfies a sensing condition, performing calculation of optical touch control based on the sensing image.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram of an existing optical touch system.

FIG. 2A is a schematic diagram illustrating luminance values detected by an existing sensor.

FIG. 2B is another schematic diagram illustrating luminance values detected by the existing sensor.

FIG. 2C is a schematic diagram illustrating luminance values detected by the existing sensor subjected to a comprehensive interference.

FIG. 2D is another schematic diagram illustrating luminance values detected by the existing sensor subjected to a comprehensive interference

FIG. 2E is a schematic diagram illustrating luminance values detected by the existing sensor subjected to a partial interference.

FIG. 3A is a schematic diagram illustrating luminance values of an example of the present invention.

FIG. 3B is a schematic diagram illustrating luminance values in accordance with another example of the present invention.

FIG. 3C is a schematic diagram illustrating luminance values in accordance with another example of the present invention.

FIG. 3D is a schematic diagram illustrating luminance values in accordance with another example of the present invention.

FIG. 4 is a flowchart illustrating a method in accordance with an embodiment of the present invention.

FIG. 5 is a flowchart illustrating an operating method in accordance with another embodiment of the present invention.

FIG. 6 is a schematic block diagram depicting an optical touch system in accordance with an embodiment of the present invention.

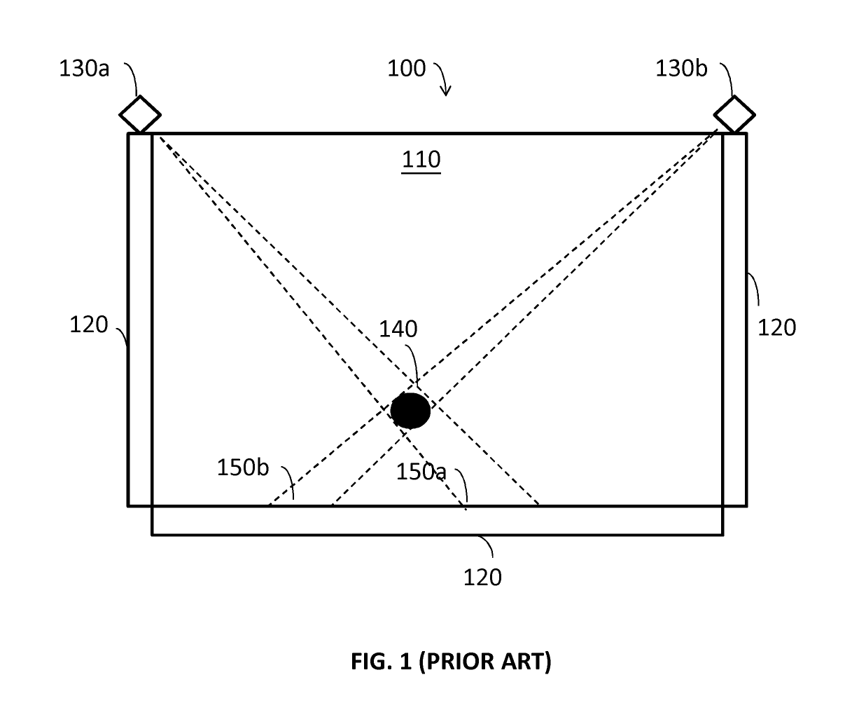

### DETAILED DESCRIPTION OF THE PREFERRED EMBODIMENTS

Some embodiments of the present invention are described in details below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

From the descriptions of the prior art, it is known that when there is external light interference, the amount of light received by the optical sensors in a predetermined sensing period t may likely to exceed the saturation value of the sensors, such that the processing apparatus of the optical sensors cannot determine if there is any shaded profiles or shaded areas of objects in the touch area hidden in the regions where the luminance values reach or is close to the saturation luminance value of the sensors, and thus cannot determine the positions of the objects.

Therefore, in accordance with the spirit of the present invention, the sensing period of the sensors is reduced, a sensing image is calculated from images obtained from a plurality of sensing, and a shaded profile or shaded area of an object in the touch area can then be found on the sensing image, thereby determining the position of the object.

In order to simplify illustration, the examples provided in the present invention all have one single object in the touch areas. One with ordinary skill in the art can appreciate that the current optical touch control techniques are applicable to multiple objects. Since the main spirit of the present invention is independent to the number of objects, so one with ordinary skill in the art can appreciate that the present invention can also be applied to embodiments in which there are more than one objects in the touch area.

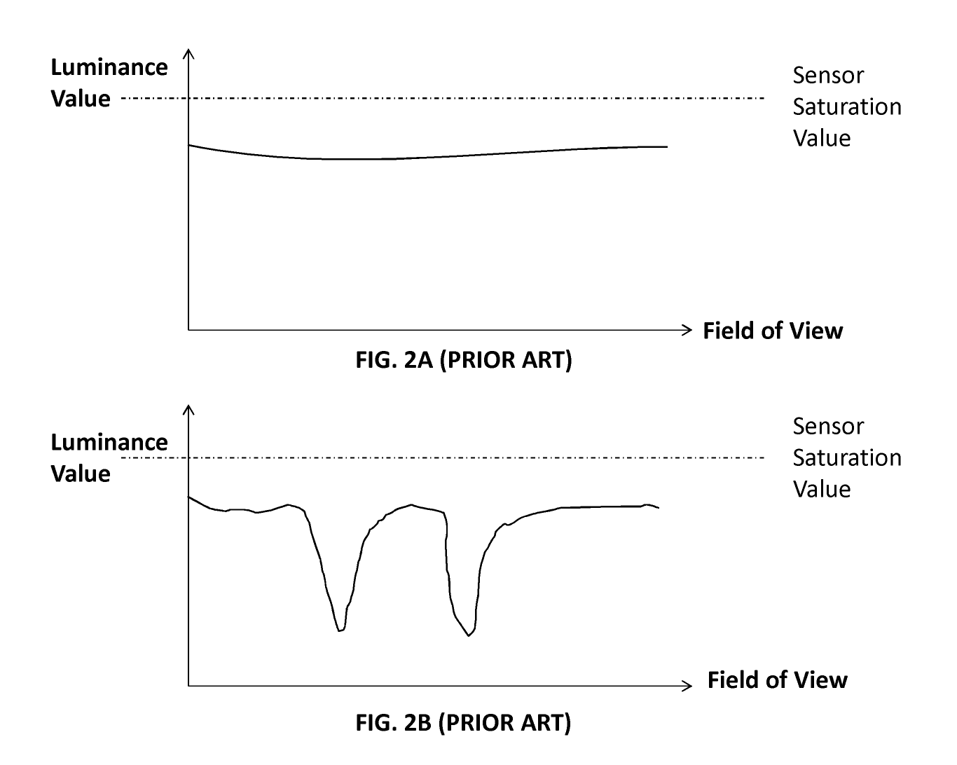

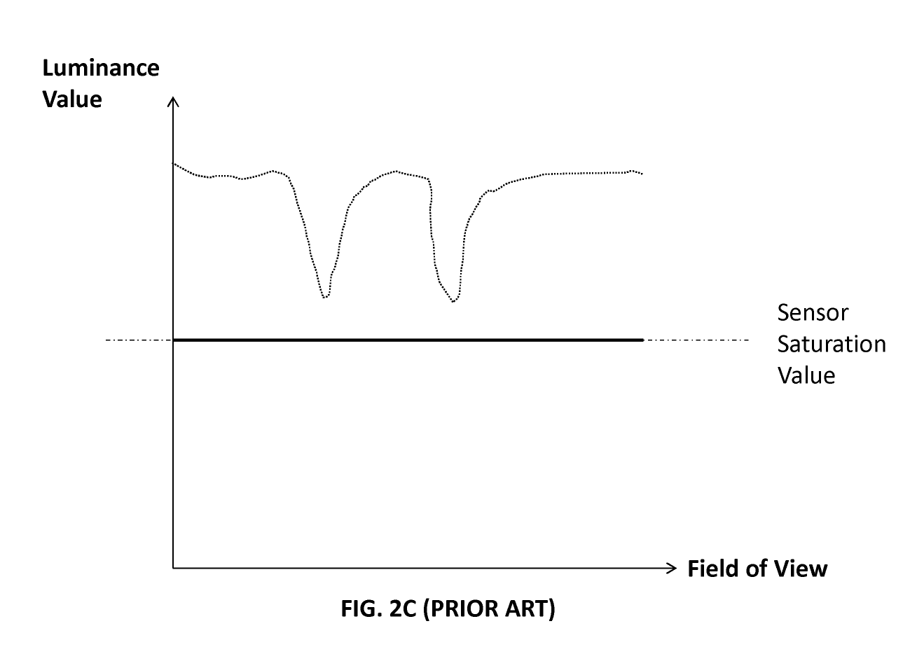

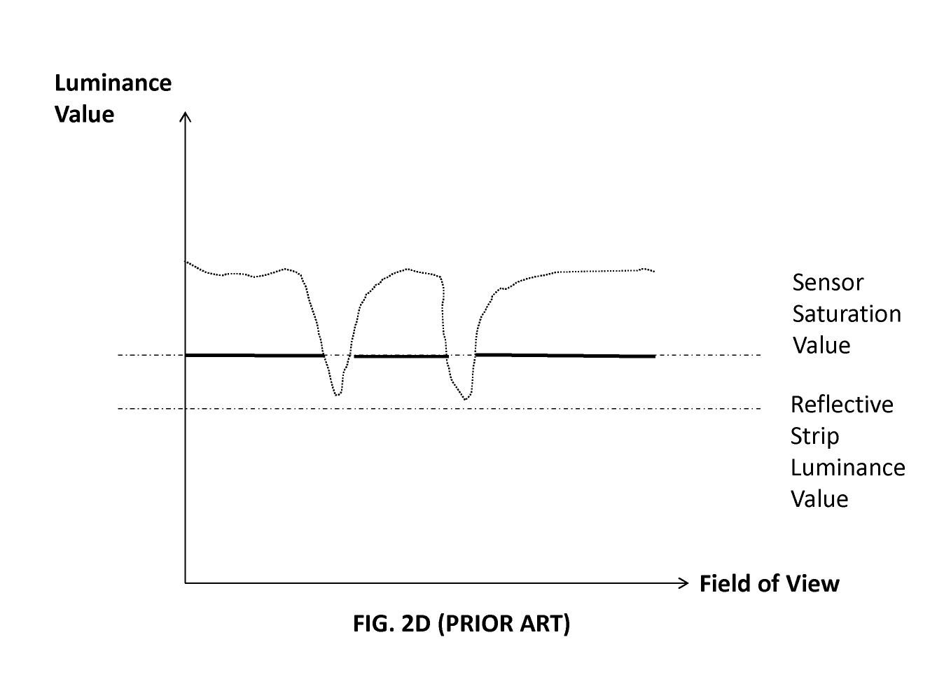

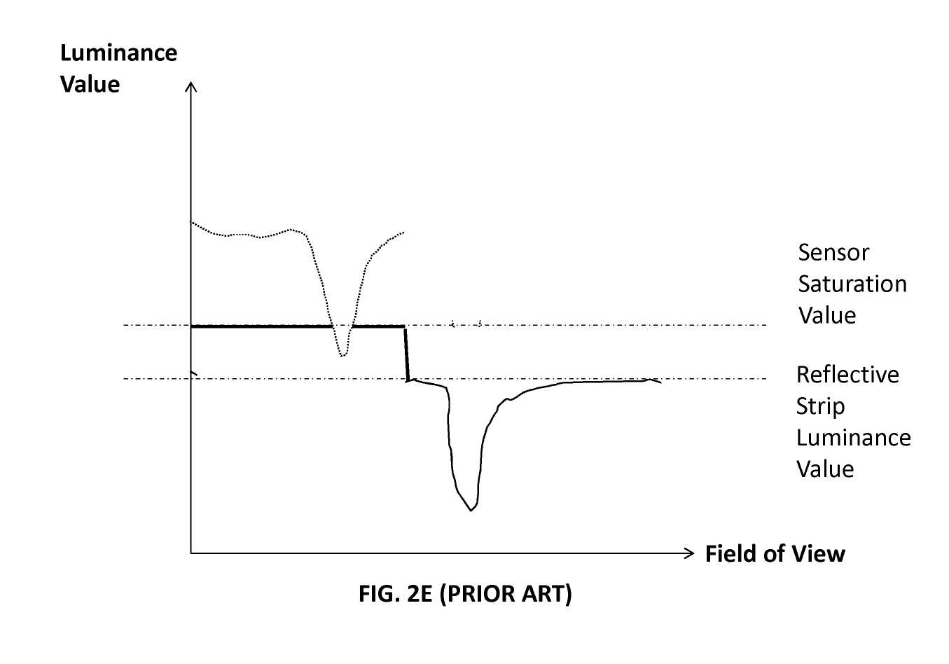

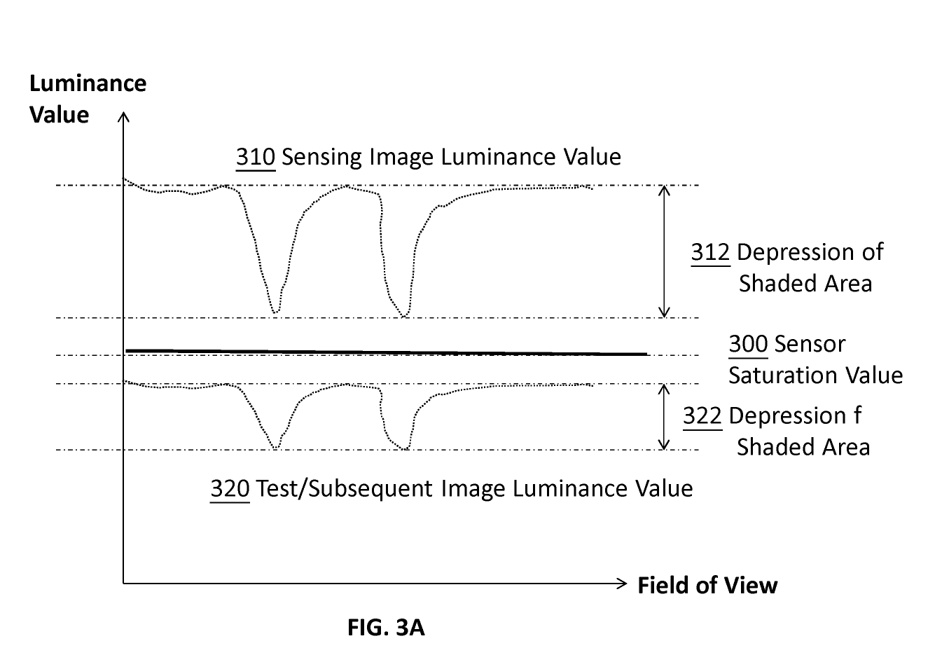

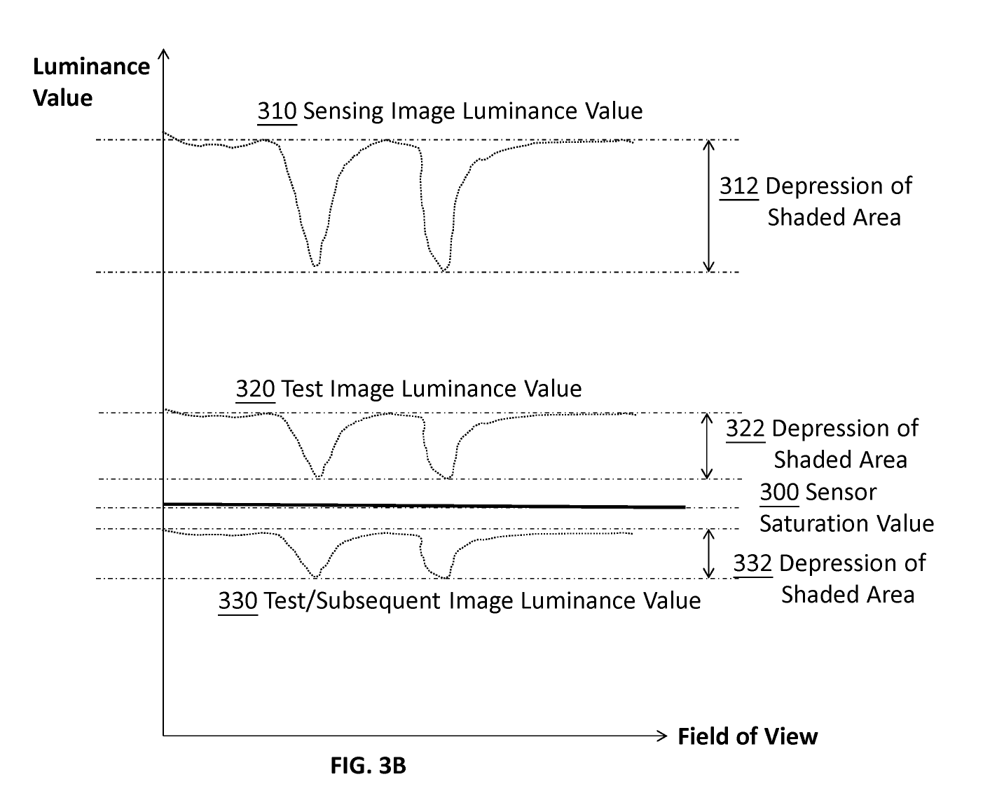

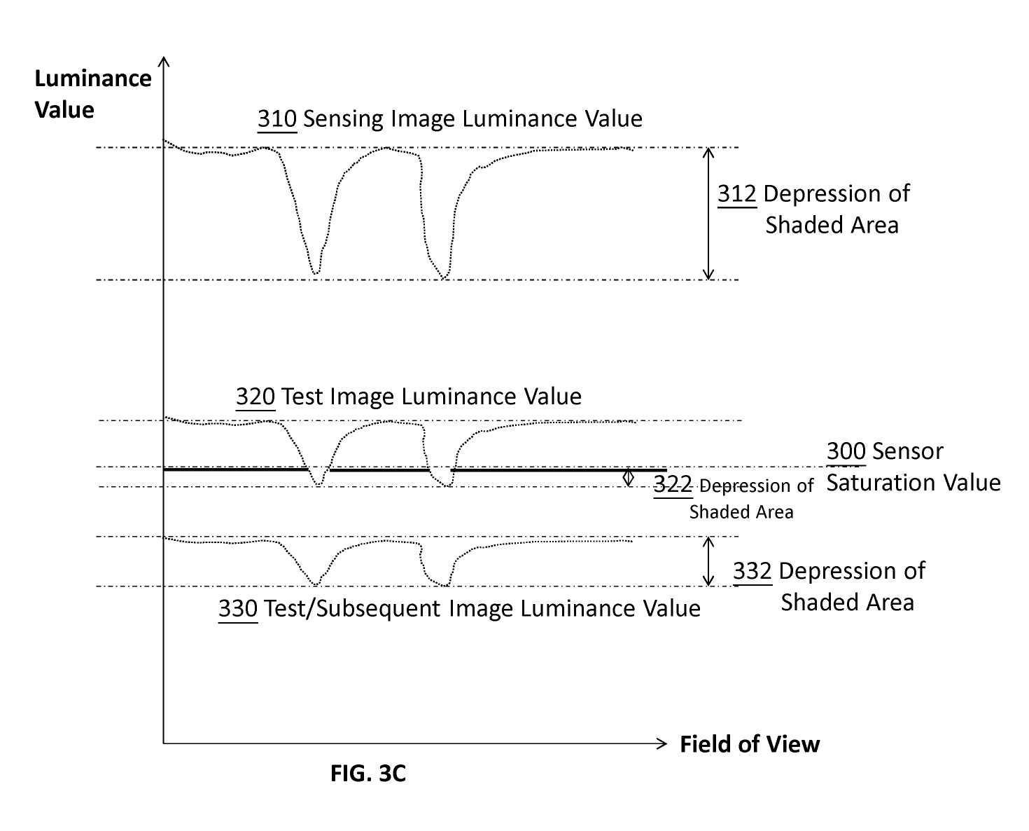

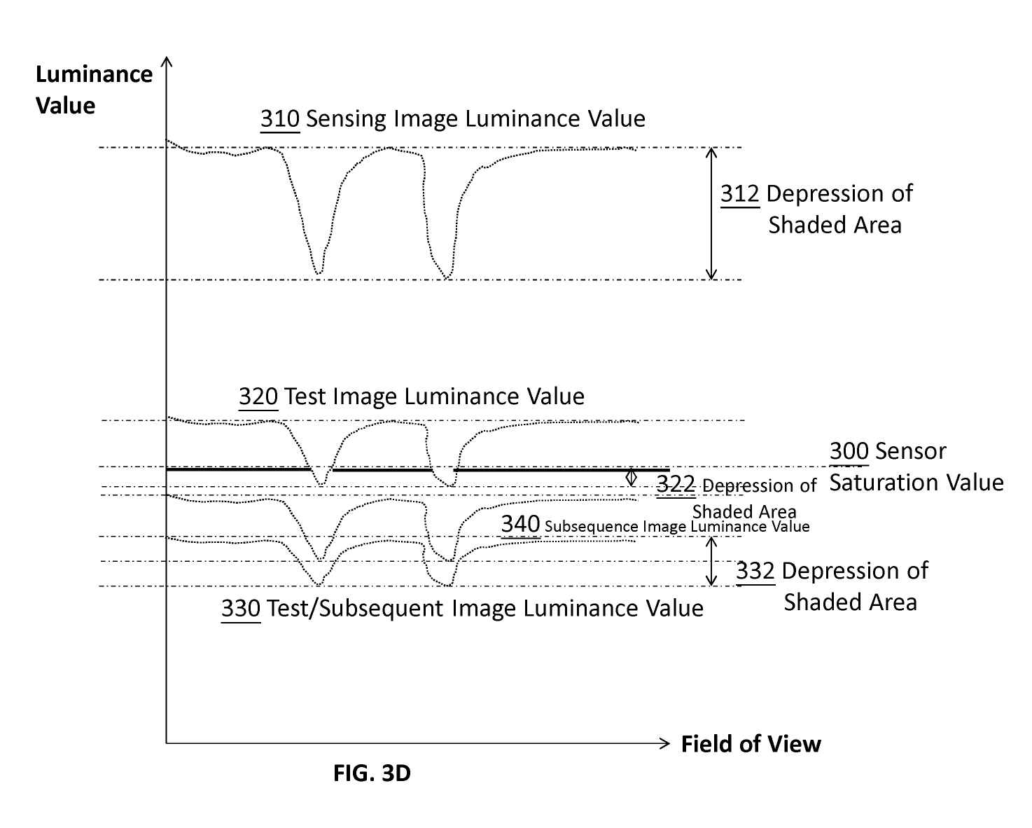

Referring to FIG. 3A, a schematic diagram illustrating luminance values of an example of the present invention is shown. The representations of the coordinates are the same as those shown in FIGS. 2A to 2E, so they will not be described further. In FIG. 3A, the saturation value (or called luminance saturation value) of a sensor 300 is indicated by a dashed line.

Assuming the saturation value of the sensor used is not limited to the saturation value 300, the luminance values obtained from the amount of external interference light plus the optical assemblies 130a and 130b is a luminance curve 310 in FIG. 3A, wherein the luminance curve 310 includes two shaded areas, wherein the drop from the curve 310 to the bottoms of the depressions of the shaded areas is indicated by 312.

However, in the predetermined sensing period t described above, the actual luminance values obtained by the sensors limited to the luminance saturation value 300 should be a line equal to the luminance saturation value 300, such as the bolder horizontal black line overlapping the luminance saturation value 300 in FIG. 3A. As such, the processing apparatus connected to the optical sensors is unable to determine any shaded areas.

When the above situation occurs, the processing apparatus may allow the optical sensors to perform sensing in a test sensing period shorter than the original predetermined sensing period t. Assuming the interference of the external light applied to the touch area is uniform with respect to time, i.e. a uniform distribution, then a luminance curve 320 shown in FIG. 3A is obtained as a result of performing sensing in half the predetermined sensing period (t/2).

Since sensing is performed in a period of t/2, so the amount of irradiation of the external interference light and the light sources of the optical assemblies 130 is halved compared to the amount of irradiation during the original period t, and the luminance curve 320 is thus below the saturation value 300 of the sensors. Similarly, the depression 322 of the shaded areas of the curve 320 is half of the depression 312 of the shaded areas of the curve 310. In other words, although the curve 320 does not exceed the luminance saturation value 300, but it is more difficult for the processing apparatus to determine where the shaded areas are.

Therefore, in an embodiment of the present invention, in a test sensing step performed by the processing apparatus, the processing apparatus recognizes the curve 320 obtained during the test sensing period t/2 as acceptable, so the processing apparatus allows the sensors to perform a subsequent sensing step based on the test sensing period t/2 of the test sensing step. Based on the previous assumptions, when the interference of the external light is uniformly distributed, then the luminance curve obtained in the subsequent sensing step should be substantially the same as the luminance curve 320 obtained in the test sensing step.

After one test sensing step and one subsequent sensing step, in one example, a test image and a subsequent image obtained from the test sensing step and the subsequent sensing step can be accumulated to obtain a sensing image. In another example, the processing apparatus may allow the sensors to perform a second subsequent sensing step in the same test sensing period as before, and then the subsequent images obtained in the two subsequent sensing steps are accumulated to obtain a sensing image. The luminance curve of this sensing image should be substantially the same as the curve 310 shown in FIG. 3A. Since the depression 312 of the shaded areas of the curve 310 is larger than the depression 322 of the shaded areas of the curve 320, it is easier for the processing apparatus to determine where the shaded areas are.

In the above examples, since two sensing steps are performed, the luminance curve 310 of the resulting sensing image can exceed the limit of the saturation value of the sensors, allowing the processing apparatus to perform the step of calculating the position of the object in the touch area.

Referring now to FIG. 3B, a schematic diagram illustrating the luminance value in accordance with another example of the present invention. Similar to FIG. 3A, the sensors of the touch system have the limitation of the luminance saturation value 300. If there is no limitation, then sensing performed in the predetermined sensing period t will result in a curve 310 much higher than the luminance saturation value 300. The curve 310 has a depression 312 of the shaded areas.

In this example, similar to the example shown in FIG. 3A, the processing apparatus allows the sensors to perform a test sensing step. The sensors perform sensing in half of the predetermined sensing period (t/2). If there is no limitation of the luminance saturation value 300, a curve 320 will be obtained. However, the curve 320 is still higher than the luminance saturation value 300, so the sensors effectively will still get a horizontal line that is equal to the luminance saturation value 300, like the bald horizontal line overlapping the luminance saturation value 300 in FIG. 3B.

Obviously, when the test sensing period is reduce to half of the predetermined sensing period, the luminance values of the test image are still saturated, so the processing apparatus allows the sensors to perform a second test sensing step. The second test sensing period is even shorter than the first test sensing period, assuming it is one third of the predetermined sensing period (t/3).

After the second test sensing step is performed, a luminance curve 330 of the test image can be obtained, which has depression 332 of the shaded areas. Since the curve 330 does not exceed the luminance saturation value 300, so the processing apparatus recognizes the test sensing period t/3 as acceptable.

In one example, the processing apparatus may allow the sensors to perform two subsequent sensing steps, both performed in period of t/3. As a result, subsequent images substantially the same as the curve 330 can be obtained. Then, the test image obtained from the previous test sensing step and the two subsequent images are accumulated to obtain a sensing image. In another example, the processing apparatus may allow the sensors to perform three subsequent sensing steps, all performed in period of t/3. As a result, subsequent images substantially the same as the curve 330 can be obtained. Then, the three subsequent images obtained from the three subsequent sensing steps are accumulated to obtain a sensing image. The luminance curve of the sensing image should be substantially the same as the curve 310 shown in FIG. 3B.

In the above examples, since three sensing steps are performed, the luminance curve 310 of the resulting sensing image can exceed the limit of the saturation value of the sensors, allowing the processing apparatus to perform the step of calculating the position of the object in the touch area.

Referring to FIG. 3C, a schematic diagram illustrating the luminance value in accordance with another example of the present invention. FIGS. 3C and 3B are similar, except that the some part of the curve obtained in the first test sensing step is higher than the luminance saturation value 300. Thus, the luminance values of most of the test image obtained in the first test sensing step are still equal to the luminance saturation value 300, only small portions of the shaded areas are below the luminance saturation value 300. Therefore, the depression 322 of the luminance curve obtained in the first test sensing step is very small. In such a situation, although the curve obtained from the first test sensing step has shaded areas, but the depression 322 of the shaded areas is too small, so the processing apparatus still instructs the sensors to perform a second test sensing step, reducing the test sensing period smaller, from t/2 to t/3. Since the example shown in FIG. 3C is the same as that of the FIG. 3B, it will not be described any further.

Referring to FIG. 3D, a schematic diagram illustrating the luminance value in accordance with another example of the present invention. FIGS. 3D and 3C are similar, except that the average luminance of the curve 330 obtained in the second test sensing step in FIG. 3D is very low, or the depression 332 of the shaded areas is too small. As a result, although the processing apparatus recognizes the second test sensing period t/3 corresponding to the curve 330 as acceptable, in the subsequent sensing step, the sensing period may be chosen to be between the first test sensing period t/2 and the second test sensing period t/3. In the example shown in FIG. 3D, the processing apparatus makes the sensing period of the subsequent sensing step 2t/5, since 2t/5 is longer than the second test sensing period t/3, but shorter than the first test sensing period t/2.

In an example, the processing apparatus may allow the sensors to perform two subsequent sensing steps each with a sensing period of 2t/5. Then, the test image with the second test sensing period t/3 and the two subsequent images are accumulated to obtain a sensing image. The summed sensing period of the sensing image is 2t/5+t/3+t/3=16t/15, which is slighter longer than the original predetermined sensing period t. Thus, the sensing image is substantially the same as the luminance curve 310 shown in FIG. 3C. In another example, the processing apparatus may allow the sensors to perform three subsequent sensing steps each with a sensing period of 2t/5. Then, the three subsequent images are accumulated to obtain a sensing image. The summed sensing period of the sensing image is 2t/5+2t/5+2t/5=6t/5, which is slighter longer than the original predetermined sensing period t. Thus, the sensing image is substantially the same as the luminance curve 310 shown in FIG. 3D.

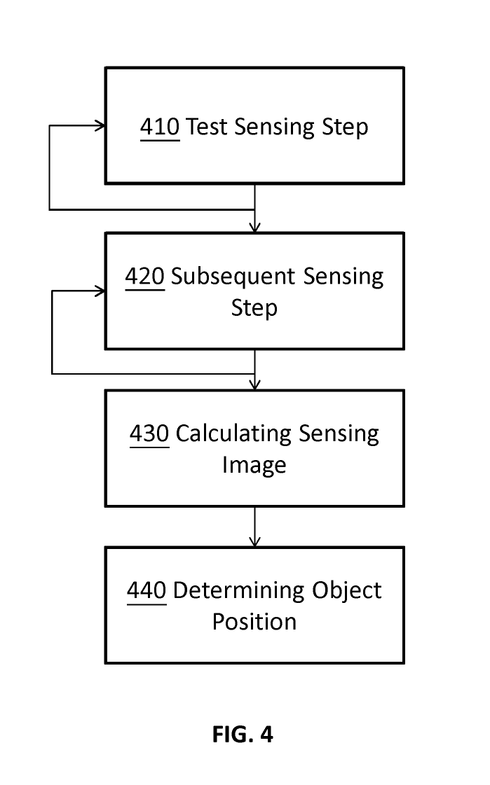

Referring to FIG. 4, a flowchart illustrating a method in accordance with an embodiment of the present invention is shown. The method is applicable to a processing apparatus of an optical touch system. The processing apparatus is used for connecting to a plurality of optical sensors, and determining the position of an object in a touch area based on output images of the plurality of sensors. The method can be implemented by software, hardware or a combination of software and hardware; the present invention is not limited as such.

First, when the processing apparatus discovers an interference of an external light on the touch area, at least a test sensing step 410 is performed. This test sensing step 410 is used for obtaining a test image and a luminance characteristic value corresponding to the test image. When the luminance characteristic value is smaller than a first threshold value, at least a subsequent sensing step is performed; else the test sensing step 410 is performed again. The test sensing period of the latter test sensing step 410 is shorter than the period of the previous test sensing step 410. As in the examples of FIGS. 3B to 3D, the test sensing period (t/3) of the second test sensing step 410 is shorter than that (t/4) of the first test sensing step 410. One with ordinary skill in the art can appreciate that although only two test sensing steps 410 are shown in the above diagrams and examples, the embodiments of the present invention are applicable to multiple test sensing steps 410. In one embodiment, the test sensing period of the first test sensing step may be the predetermined sensing period t as mentioned earlier, or t/2 described in FIGS. 3A to 3D.

In one embodiment, the luminance characteristic value may be the maximum luminance value in the test image, and the first threshold value may be the luminance saturation value of the optical sensors. In other words, as long as the luminance value of a part of the test image reaches saturation, the test sensing period is reduced and the test sensing step 410 is repeated.

In another embodiment, the luminance characteristic value may be the sum or average of all the luminance values in the test image. When the sum or average of all the luminance values in the test image reaches saturation, the test sensing period is reduced and the test sensing step 410 is repeated.

In still another embodiment, the luminance characteristic value may be the sum or average of luminance values in at least one calibration area in the test image. The at least one calibration area may be at least one special indicator among the reflective strips 120, which can be used for calibrating coordinate values in the optical touch system. One with ordinary skill in the art can appreciate that when the optical touch system is in use, the viewing angles of the optical assemblies 130a and 130b has to be aimed at specific directions in order to minimize the errors in calculating the position. In some optical touch systems, if the reflective strips 120 include at least one special indicator thereon for calculating the coordinate values of the object in the touch area, the coordinate values are first calibrated using the known special indicator. If the sum or average of the luminance values in the calibration region to which the special indicator corresponds is higher than the first threshold value, then the optical touch system cannot carry out calibration. Thus, in this embodiment, the processing apparatus can reduce the test sensing period and repeat the test sensing step 410.

After the last test sensing step 410 is finished, the method further includes performing at least one subsequent sensing step 420 based on the test sensing period of the last test sensing step to obtain at least one subsequent image. As in an embodiment shown in FIG. 3A, the test sensing period t/2 of a subsequent sensing step 420 performed once or twice is the same as the test sensing period t/2 of the test sensing step 410. In the embodiments shown in FIGS. 3B and 3C, the test sensing period t/3 of a subsequent sensing step 420 performed twice or three times is the same as the test sensing period t/3 of the second test sensing step 410.

Take FIG. 3A as an example, in an embodiment where the predetermined sensing period t is used as the test sensing period of the first test sensing step 410, the number of subsequent sensing steps performed is the quotient of the test sensing period of the first test sensing step 410 divided by the test sensing period of the last test sensing step 410. In other words, the quotient of t divided by t/2 is 2, so in this embodiment, the number of subsequent sensing steps performed is two. If FIGS. 3B and 3C are taken as an example, in an embodiment where the predetermined sensing period t is used as the test sensing period of the first test sensing step 410, the number of subsequent sensing steps performed is the quotient of the test sensing period of the first test sensing step 410 divided by the test sensing period of the last test sensing step 410. In other words, the quotient of t divided by t/3 is 3, so in this embodiment, the number of subsequent sensing steps performed is three.

After the last subsequent sensing step 420 is finished, step 430 is performed to calculate a sensing image. As the embodiment shown in FIG. 3A, the sensing image is obtained by accumulating the subsequent images obtained from performing the subsequent sensing step 420 once or twice together. As the embodiments shown in FIGS. 3B and 3C, the sensing image is obtained by accumulating the subsequent images obtained from performing the subsequent sensing step 420 twice or three times together.

In the subsequent images obtained in FIGS. 3A to 3D, each subsequent image includes a luminance curve having a plurality of luminance values. Each luminance value corresponds to a position in the field of view of the sensor. The sum of the luminance values corresponding to the same position in all the subsequent images is equivalent to the luminance value of the same position in the sensing image. In other words, the luminance value of each position in the sensing image corresponds to the accumulation of all the luminance values in the subsequent images corresponding to that position.

After the step 430 for calculating a sensing image is finished, a step 440 for determining a position is performed to determine the position of each object in the sensing image. The step 440 for determining a position may include detecting a shaded profile or a shaded area corresponding to each object in the sensing image, and calculating the position of the corresponding object based on the value of the shaded profile or the shaded area. In an embodiment, when detecting a shaded profile or shaded area, the minimum luminance value of the shaded profile or shaded area is less than a second threshold value.

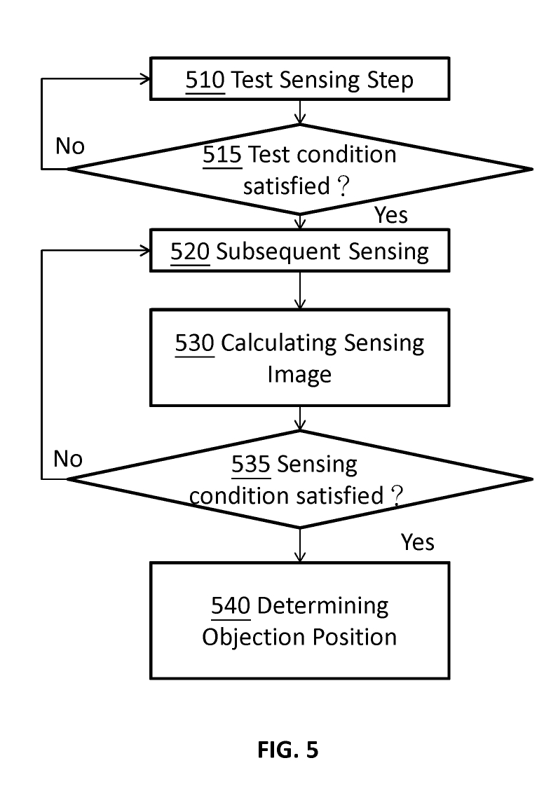

Referring to FIG. 5, a flowchart illustrating an operating method in accordance with another embodiment of the present invention is shown. Similar to the embodiment shown in FIG. 4, the operating method is applicable to a processing apparatus of an optical touch system. The operating method includes performing at least one test sensing step 510. Optical sensing is performed in a test sensing period to obtain a first luminance characteristic value and a second luminance characteristic value of a test image, wherein the test sensing period is shorter than a predetermined sensing period. In each of the embodiments of FIGS. 3A to 3D, the test sensing step 510 may perform optical sensing in a test sensing period of t/2, t/3 and 2t/5, which are all shorter than the predetermined sensing period t.

After the test sensing step 510 is performed once, a determining step 520 is performed to determine if the first and second luminance characteristic values satisfy a test condition. In an embodiment, the test condition is when the first luminance characteristic value of the test image is smaller than a first threshold value and the second luminance characteristic value of the test image is smaller than a second threshold value, wherein the first threshold value is higher than the second threshold value. The first threshold value may be the luminance saturation value of the sensors.

The first luminance characteristic value may be one of the following: the average or sum of luminance values of the test image; the maximum luminance value of the test image; and the luminance value of at least one calibration area of the test image. The second luminance characteristic value may be one of the following: the minimum luminance value of the test image; the average or sum of luminance values of at least one shaded area in the test image, the shaded area including the minimum luminance value in the test image; and the average or sum of luminance values of a plurality of shaded areas in the test image, the shaded areas each including a luminance value smaller than a shade value in the test image.

In another embodiment of the present invention, a test condition for the determining step 515 is when the first luminance characteristic value of the test image is smaller than a first threshold value and a third luminance characteristic value of the test image is larger than a third threshold value, wherein the third luminance characteristic value is the difference between the first luminance characteristic value and the second luminance characteristic value. In other words, the processing apparatus in this embodiment also needs to consider that the depression of the shaded area in the luminance curve in the test image is larger than the third luminance characteristic value. When the first luminance characteristic value is smaller than the first threshold, and the depression of the shaded area is larger than the third threshold, i.e. when the above test condition is satisfied, then the processing apparatus uses the test sensing period of this test sensing step in a subsequent sensing step 520.

When the determining step 515 determines that the test condition is not satisfied, the test sensing step 510 is repeated until the first luminance characteristic value and the second luminance characteristic value of the new test image obtained in the new test sensing step satisfy the test condition. The test sensing period of each test sensing step 510 is shorter than the test sensing period of the pervious test sensing step 510, as with the test sensing period changing from t/2 to t/3 in FIGS. 3B to 3D.

When the determining step 515 determines that the last test sensing step 510 satisfies the test condition, then at least one subsequent sensing step 520 is performed to obtain a subsequent image. After the at least one subsequent sensing step 520 is performed, step 530 is proceeded to calculate a sensing image. As with various embodiments previously mentioned, the sensing image may include the above subsequent image, and may also include the test image obtained in the last test sensing step.

Then, a determining step 535 is performed to determine if the sensing image satisfies a sensing condition. In an embodiment, the processing apparatus requires the sensing image to have distinct shaded area(s) or shaded profile(s). Thus, the above sensing condition includes that a third luminance characteristic value of the sensing image to be higher than a fourth threshold value. The third luminance characteristic value is the difference between a first luminance characteristic value and a second luminance characteristic value of the sensing image. When the third luminance characteristic value representing the depression of a shaded area is higher than the fourth threshold value, it implies that the processing apparatus can successfully find the shaded area or shaded profile.

The first luminance characteristic value of the sensing image may be one of the following: the average luminance value of the sensing image; the maximum luminance value or the sum of luminance values of the sensing image; and the luminance value of at least one calibration area of the sensing image. The second luminance characteristic value may be one of the following: the minimum luminance value of the test image; the average or sum of luminance values of at least one shaded area in the sensing image, the shaded area including the minimum luminance value in the sensing image; and the average or sum of luminance values of a plurality of shaded areas in the sensing image, the shaded areas each including a luminance value smaller than a shade value in the sensing image.

When the determining step 535 determines that the above sensing image cannot satisfy the sensing condition, the operating method performs at least another subsequent sensing step 520 and the sensing image calculating step 530. The sensing image calculating step 530 is the accumulation of subsequent images including the subsequent image obtained from the latest subsequent sensing step 520.

In the embodiments of FIGS. 3B and 3C, the subsequent sensing periods of the plurality of subsequent sensing steps are all the same, that is, equal to t/3, which is the latest test sensing period. In these embodiments, the sum of the subsequent sensing periods (t/3 each) of three subsequent sensing steps is equal to the predetermined sensing period t.

In the two embodiments of FIG. 3D, the sum of the subsequent sensing periods of the plurality of subsequent sensing steps are 16t/15 and 6t/5, respectively, which are both larger than the predetermined sensing period t, but smaller than a certain multiple of the predetermined sensing period.

In the embodiments of FIGS. 3A to 3D, the sensing image may include the accumulation of a plurality of subsequent images, but may not include any test images. The sensing image may include the accumulation of at least one subsequent image and the last test image. In the embodiment of FIG. 3C, the sum of the subsequent sensing periods (t/3 each) of the two subsequent sensing steps and the latest test sensing period (t/3) is equal to the predetermined sensing period t.

In the two embodiments of FIG. 3D, the sum of the subsequent sensing periods of two subsequent sensing steps and the latest test sensing period are 16t/15 and 6t/5, respectively, which are both larger than the predetermined sensing period t, but smaller than a certain multiple of the predetermined sensing period.

When the first threshold value is equal to the luminance saturation value of the sensors, the first luminance characteristic value of the sensing image is larger than the first threshold value. In the first few paragraphs of Detailed Description of Preferred Embodiments, the main principle of the present invention is to perform sensing using a plurality of shorter time periods, so that the luminance value of each sensing is not saturated, but the first luminance characteristic value of the sensing image accumulated after sensing can be larger than the first threshold value.

In an embodiment, when the second luminance characteristic value of the latest test image is larger than a fifth threshold value, the subsequent sensing period of the first subsequent sensing step 520 is shorter than the latest test sensing period, whereas when the second luminance characteristic value of the latest test image is smaller than the fifth threshold value, the subsequent sensing period of the first subsequent sensing step 520 is longer than the latest test sensing period. Returning to FIG. 3D, since the test sensing period of the test image in the third test sensing step is t/3, and its second luminance characteristic value is smaller than the fifth threshold value, the subsequent sensing period (2t/5) of the first subsequent sensing step 520 is longer than the latest test sensing period (t/3). Although a situation where the second luminance characteristic value of the test image is larger than the fifth threshold value is not shown in the specification, one with ordinary skill in the art can easily derive the situation, and the present invention will not illustrate it in details.

Similarly, in another embodiment, when the subsequent sensing step 520 is performed several times, the method further includes calculating the second luminance characteristic value of the subsequent sensing image obtained from each subsequent sensing step 520. When the second luminance characteristic value of a first subsequent sensing step 520 is larger than a fifth threshold value, then the subsequent sensing period of a second subsequent sensing step 520 performed after the first subsequent sensing step 520 is shorter than the subsequent sensing period of the first subsequent sensing step, whereas when the second luminance characteristic value of the first subsequent sensing step 520 is smaller than the fifth threshold value, then the subsequent sensing period of the second subsequent sensing step 520 is longer than the subsequent sensing period of the first subsequent sensing step 520.

In an embodiment of the present invention, if partial interference shown in FIG. 2E is encountered, then the area of this partial interference can be segmented out from the full field of view, and then the operating methods shown in FIG. 4 or 5 is carried out. One with ordinary skill in the art can appreciate that the first luminance characteristic value of the luminance curve of the partially interfered area will exceed the first threshold value, so the operating method provided by the present invention only needs to be applied to the partially interfered area in order to find the shaded area(s) or shaded profile(s) of the partially interfered area, and thus the details of which will not be repeated.

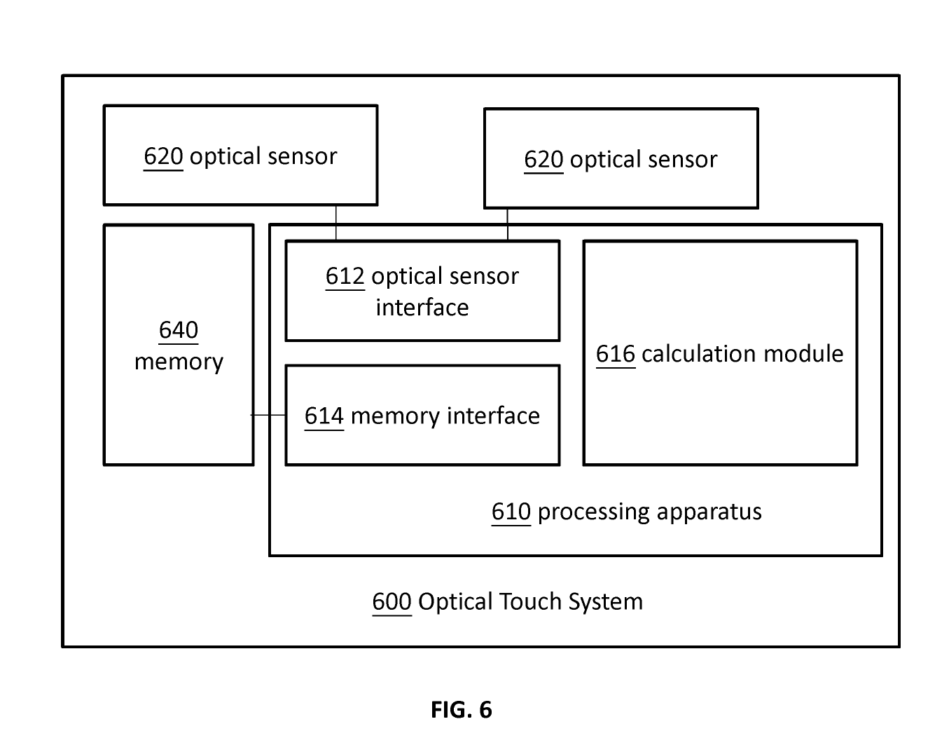

Referring to FIG. 6, a schematic block diagram depicting an optical touch system 600 in accordance with an embodiment of the best mode of the present invention is shown. The optical touch system 600 may be part of a computer system, including a processing apparatus 610, a plurality of optical sensors 620, and at least one memory 640. The processing apparatus 610 includes an optical sensor interface 612 for connecting to the plurality of optical sensors 620, a memory interface 614 for connecting to the memory 640, and a calculation module 616 connected to the optical sensor interface 612 and the memory interface 614. The calculation module 616 is used to execute the operating methods shown in FIGS. 4 and 5 according to a program in the memory 640.

In one example, the processing apparatus 610 and the memory 640 can be packaged in the same chip, and connected to the plurality of optical sensors 620 via a pin interface of the chip. In another example, the memory interface 614 of the processing apparatus 610 is connected to the memory 640 via a bridging device (not shown), for example, connected to ROM and system memory via a Northbridge/Southbridge chipset of a personal computer. The personal computer can be consisted of a SoC (System on Chip). In an embodiment, the SoC includes the calculation module and the memory interface. One with ordinary skill in the art can appreciate that the processing apparatus 610 may have numerous different implementations.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. An operating method of an optical touch system comprising:
performing at least one test sensing step to obtain a luminance characteristic value until the luminance characteristic value is smaller than a first threshold value, a test sensing period of each test sensing step is shorter than the test sensing period of the previous test sensing step;
performing at least one subsequent sensing step to obtain at least one subsequent image based on the test sensing period of the last test sensing step;
calculating a sensing image based on the at least one subsequent image; and
performing a position determining step to determine the position of each object in the sensing image.

2. The operating method of claim 1, wherein the number of at least one subsequent sensing step performed is the quotient of the test sensing period of the first test sensing step divided by the test sensing period of the last test sensing step.

3. The operating method of claim 1, wherein the position determining step includes:
detecting each shaded profile corresponding to an object in the sensing image; and
calculating the position of the corresponding object based on the value of each shaded profile.

4. The operating method of claim 3, wherein the minimum luminance value of each shaded profile corresponding to an object is smaller than a second threshold.

5. The operating method of claim 1, wherein a test image is obtained in each test sensing step, and the luminance characteristic value is one of the following:
the maximum luminance value in the test image;
the sum or average of all luminance values in the test image; and
the sum or average of luminance values in at least one calibration area in the test image.

6. The operating method of claim 1, wherein each subsequent image includes a plurality of luminance values, each luminance value corresponds to a position, wherein the sum of luminance values corresponding to the same position in all the subsequent images constitute a luminance value corresponding to the same position in the sensing image.

7. An operating method of an optical touch system comprising:
performing at least one test sensing step to carry out optical sensing in a test sensing period to obtain a first luminance characteristic value and a second luminance characteristic value of a test image, wherein the test sensing period is shorter than a predetermined sensing period;
when the first luminance characteristic value and the second luminance characteristic value satisfy a test condition, performing at least one subsequent sensing step to obtain at least one subsequent image;
calculating a sensing image based on the subsequent image; and
when the sensing image satisfies a sensing condition, performing calculation of optical touch control based on the sensing image.

8. The operating method of claim 7, wherein the test condition is satisfied when the first luminance characteristic value of the test image is lower than a first threshold value and the second luminance characteristic value of the test image is lower than a second threshold value, wherein the first threshold value is higher than the second threshold value.

9. The operating method of claim 7, wherein the first luminance characteristic value is one of the following:
the sum or average of all the luminance values in the test image;
the maximum luminance value in the test image; and
a luminance value in at least one calibration area in the test image.

10. The operating method of claim 8, wherein the second luminance characteristic value is one of the following:
the minimum luminance value of the test image;
the average or sum of luminance values of at least one shaded area in the test image, the shaded area including the minimum luminance value in the test image; and
the average or sum of luminance values of a plurality of shaded areas in the test image, the shaded areas each including a luminance value smaller than a shade value in the test image.

11. The operating method of claim 7, wherein the test condition is when the first luminance characteristic value of the test image is smaller than a first threshold value and a third luminance characteristic value of the test image is larger than a third threshold value, wherein the third luminance characteristic value is the difference between the first luminance characteristic value and the second luminance characteristic value, the second luminance characteristic value is one of the following:
the minimum luminance value of the test image;
the average or sum of luminance values of at least one shaded area in the test image, the shaded area including the minimum luminance value in the test image; and
the average or sum of luminance values of a plurality of shaded areas in the test image, the shaded areas each including a luminance value smaller than a shade value in the test image.

12. The operating method of claim 7, wherein if the first luminance characteristic value and the second luminance characteristic value do not satisfy the test condition, then the test sensing step is repeated until the first luminance characteristic value and the second luminance characteristic value of a new test image obtained from the new test sensing step satisfy the test condition, wherein the test sensing period of each test sensing step is shorter than the test sensing period of the previous test sensing step.

13. The operating method of claim 7, wherein the sensing condition is when a third luminance characteristic value of the sensing image is larger than a fourth threshold value, wherein the third luminance characteristic value is the difference between a first luminance characteristic value of the sensing image and a second luminance characteristic value of the sensing image, wherein the first luminance characteristic value of the sensing image is one of the following:
the average luminance value of the sensing image;
the maximum luminance value of the sum of luminance values of the sensing image; and
a luminance value of at least one calibration area of the sensing image, wherein the second luminance characteristic value of the sensing image is one of the following:
the minimum luminance value of the sensing image;
the average or sum of luminance values of at least one shaded area in the sensing image, the shaded area including the minimum luminance value in the sensing image; and
the average or sum of luminance values of a plurality of shaded areas in the sensing image, the shaded areas each including a luminance value smaller than a shade value in the sensing image.

14. The operating method of claim 7, further comprising, when the sensing condition is not satisfied, performing at least one additional subsequent sensing step to obtain at least one additional subsequent image, the sensing image including an accumulation of a plurality of subsequent images.

15. The operating method of claim 14, wherein the subsequent sensing periods of the plurality of subsequent sensing steps are all equal.

16. The operating method of claim 14, wherein the sum of the subsequent sensing periods of the plurality of subsequent sensing steps is equal to the predetermined sensing period.

17. The operating method of claim 14, wherein the sum of the subsequent sensing periods of the plurality of subsequent sensing steps is larger than the predetermined sensing period, but smaller than a certain multiple of the predetermined sensing period.

18. The operating method of claim 7, wherein the sensing image includes an accumulation of the subsequent image and the test image.

19. The operating method of claim 18, wherein the subsequent sensing period of each subsequent sensing step is equal to the latest test sensing period.

20. The operating method of claim 18, wherein the sum of the subsequent sensing period of each subsequent sensing step and the latest test sensing period is equal to the predetermined sensing period.

21. The operating method of claim 18, wherein the sum of the subsequent sensing period of each subsequent sensing step and the latest test sensing period is larger than the predetermined sensing period, but smaller than a certain multiple of the predetermined sensing period.

22. The operating method of claim 18, wherein the first luminance characteristic value of the sensing image is larger than the first threshold value.

23. The operating method of claim 14, further comprising, when the subsequent sensing step is performed a plurality of times, calculating the second luminance characteristic value of subsequent sensing image obtained from each subsequent sensing step, wherein when the second luminance characteristic value obtained from the first subsequent sensing step is larger than a fifth threshold value, then the subsequent sensing period of a second subsequent sensing step performed after the first subsequent sensing step is shorter than the subsequent sensing period of the first subsequent sensing step, whereas when the second luminance characteristic value of the first subsequent sensing step is smaller than the fifth threshold value, then the subsequent sensing period of the second subsequent sensing step is longer than the subsequent sensing period of the first subsequent sensing step.

24. The operating method of claim 7, wherein when the second luminance characteristic value of the latest test image is larger than a fifth threshold value, the subsequent sensing period of the first subsequent sensing step is shorter than the latest test sensing period, whereas when the second luminance characteristic value of the latest test image is smaller than the fifth threshold value, the subsequent sensing period of the first subsequent sensing step is longer than the latest test sensing period.

25. The operating method of claim 7, wherein when the test sensing period is equal to the predetermined sensing period, at least one of the first luminance characteristic value and the second luminance characteristic value of the test image is higher than a first threshold value, wherein the first threshold value is the saturation luminance value of an optical sensing apparatus in the optical touch system.

26. A processing apparatus applicable to an optical touch system for processing a plurality of optical sensors of the optical touch system, the processing apparatus comprising:
an optical sensor interface connected with the plurality of optical sensors;
a memory interface connected with a memory; and
a calculation module connected with the optical sensor interface and the memory interface for executing an operating method in accordance with instructions stored in the memory, wherein the operating method includes:
performing at least one test sensing step to obtain a luminance characteristic value until the luminance characteristic value is smaller than a first threshold value, the test sensing period of each test sensing step is shorter than the test sensing period of the previous test sensing step;
performing at least one subsequent sensing step to obtain at least one subsequent image based on the test sensing period of the last test sensing step;
calculating a sensing image based on the at least one subsequent image; and
performing a position determining step to determine the position of each object in the sensing image.

27. A processing apparatus applicable to an optical touch system for processing a plurality of optical sensors of the optical touch system, the processing apparatus comprising:
an optical sensor interface connected with the plurality of optical sensors;
a memory interface connected with a memory; and
a calculation module connected with the optical sensor interface and the memory interface for executing an operating method in accordance with instructions stored in the memory, wherein the operating method includes:
performing at least one test sensing step to carry out optical sensing in a test sensing period to obtain a first luminance characteristic value and a second luminance characteristic value of a test image, wherein the test sensing period is shorter than a predetermined sensing period;
when the first luminance characteristic value and the second luminance characteristic value satisfy a test condition, performing at least one subsequent sensing step to obtain at least one subsequent image;
calculating a sensing image based on the subsequent image; and
when the sensing image satisfies a sensing condition, performing calculation of optical touch control based on the sensing image.
